(19) United States
(12) Patent Application Publication
(10) Pub. No.: US 2015/0202911 A1
(43) Pub. Date: Jul. 23, 2015

(54) LOOSE LEAF BINDER

(71) Applicant: Kaneda Company Limited, Ota-ku, TY (JP)

(72) Inventor: Toru Kaneda, Ota-ku (JP)

(73) Assignee: Kaneda Company Limited, Ota-ku, TY (JP)

(21) Appl. No.: 14/408,842

(22) PCT Filed: Jun. 19, 2013
(86) PCT No.: PCT/JP2013/066872

§ 371 Date: Dec. 17, 2014

(30) Foreign Application Priority Data
Jun. 21, 2012 (JP) 2012-140008
Jan. 17, 2013 (JP) 2013-006508

(51) Int. Cl. B42F 13/22; B42F 13/26

(52) U.S. Cl. CPC B42F 13/22; B42F 13/26

(57) ABSTRACT

When the half rings are opened, the position of the opened half rings is not stable and therefore it was difficult to insert or remove the loose leaf or leaves. A loose leaf binder comprising: base plates (42, 44) arranged side-by-side and supported by a axis with each other; half rings (20, 30) fixed to and supported on the base plates (42, 44) respectively; and a spring normally biasing the base plates (42, 44) toward opened direction, wherein at least one hook (104) is formed on the one base plate (42 or 44) and adapted to engage with an outer edge of the other base plate when the half rings (20, 30) are in the closed position, and at least one lock release groove (108) is formed on the other base plate (44 or 42) and adapted to release the hook (104) from the engagement with the outer edge when the half rings (20, 30) are displaced to the second position where the half rings (20, 30) are not aligned and the hook (104) drops into the lock release groove (108), and wherein the loose leaf binder comprises a coil spring (102) adapted to normally bias the both base plates (42, 44) toward the first position where the half rings (20,30) are aligned with each other and a spring adopted to open the half rings when the lock is released.

### TECHNICAL FIELD

The present invention relates to a binder for binding loose leaves, and more particularly to a slim binder having a structure wherein the loose leaves can be turned over up to 360 degrees.

### BACKGROUND TECHNOLOGY

The typical conventional loose leaf binder comprises a pair of first and second elongated base plates, a first set of half rings upstanding from the first base plate and a second set of half rings upstanding from the second base plate and having free ends capable of being bought into contact with the free ends of the first half rings to form rings. When the loose leaf or leaves are to be filed or exchanged, the base plates are relatively moved up and down or horizontally swung from each other so as to open or close the rings.

Among them, the loose leaf binder of the type in which a first base plate and second base plate, each having respective half rings, are side-by-side arranged and are connected with a common shaft and rotated around their common shaft to close and open the free ends of both half rings, has an advantage that the loose leaf or leaves can be turned up to 360 degrees around the shaft in the closed portion of the binder. However, if there is no restriction to the free ends of the half rings in the closed position, the closed rings and the base plates can be easily rotated when an external force is applied and, accordingly, the free ends of the half rings were shaped into hooks so that the half rings are not opened in the closed condition.

However, when the rings must be opened, this configuration requests to relatively move the base plates in the axial and opposite directions for a sufficient length to unlock the hooks of the half rings. Once opened, there is no more restriction and thus the open angle between the ends of both half rings is not stable and the position of the both base plates are not stable, either. This was inconvenient for the users who want to insert or remove the half rings into or from the holes of loose leaves.

### SUMMARY OF THE INVENTION

### Problem to be Solved by the Invention

As above-discussed, according to the conventional technique, the position of the opened half rings is not stable, it is necessary to hold the half rings with fingers when the loose leaf or leaves are to be inserted or removed, and thus it is not easy to insert or remove the loose leaf or leaves.

In addition, in the conventional technique, the free ends of the half rings are in the form of hooks and accordingly when the user wants to open the rings it is necessary to relatively move the half rings for a substantial distance in opposite directions to unlock the locks at the free ends of the half rings.

Accordingly, an object of the present invention is to provide a binder having half rings with no hook at their free ends, wherein both of the half rings can be securely kept closed, but can be easily opened when necessary.

Another object of the present invention is to provide a binder, wherein the free ends of the half rings can be easily opened and stably kept in the opened position.

A further object of the present invention is to provide a loose leaf binder, wherein each pair of the half rings are provided with a recess and a protrusion at the respective free ends which are adapted to be mutually engaged in vertical direction (not in the longitudinal direction as in the conventional half-rings) thereby to enhance the capability of retaining the loose leaf or leaves, and when necessary the half rings can be opened and immediately after their opening the half rings return to the position in alignment with each other. At the time of closing the half rings, the half rings are rotated, while keeping the mutual alignment, to the closed position and their recesses and projections are engaged with each other. Thus, the insertion and removal of the loose leaf or leaves can be stably and easily performed and the closure of the rings becomes more reliable.

In addition to these objects, the present invention further aims at solving other problems which will be explained in the followings.

### Means for Solving the Problem

The inventor has conducted an extensive study and has invented the following binder for loose leaf or leaves.

(1) A loose leaf binder comprising: a pair of elongated base plates (42, 44) arranged side-by-side; a plurality of half rings (20, 30) integrally supported respectively on these base plates, in such manner that half rings form closed rings when their respective pairs of the free ends abut each other; a plurality of bearings (14) formed integrally with rear surfaces of the respective base plates (42, 44) and having a common axis between the base plates, a gap formed between the bearings (44) in such manner that the base plates can be relatively moved along the common axis between a first position where respective pairs of half rings (20, 30) are aligned with each other and a second position where the respective pairs of half rings (20, 30) are not aligned; and a shaft or shafts supported by the bearings (14) on the rear surface of the base plates (42, 44), wherein

at least one hook (104) formed on the one base plate (42 or 44) and adapted to engage with the outer edge when the half rings (20, 30) are in the closed position, and

at least one lock release groove (106) formed on the other base plate (44 or 42) and adapted to release the hook (104) from the engagement with the outer edge when the half rings (20, 30) are displaced to the second position where the half rings (20, 30) are not aligned and the hook (104) drops into the lock release groove (106).

According to the above configuration (1), the free ends of the half rings may not be provided with hooks but are simply provided with superposing or nesting structure, whereby loose leaf or leaves can be held stably in the closed condition and the half rings may be easily opened when necessary. Also, since the free ends of the half rings are not provided with hooks, the mold for plastic molding of the base plate and other integral parts can be easily produced.

(2) The loose leaf binder according to the above configuration (1), further comprising a coil spring (102) adapted to normally bias the both base plates (42, 44) toward the first position where the half rings (20,30) are aligned with each other.

According to this configuration, when the finger is released after the half rings are opened, the restoring force under the compression of the coil spring (102) will make both base plates mutually slide in the longitudinal direction to the position where the opened half rings occupy the mutually aligned positions.

(3) The loose leaf binder according to the above configuration (2), wherein the coil spring (102) has legs (102a, 102b) engaged with the inner edges of the both base plates (42, 44), the legs normally biasing the half rings (20, 30) toward an open position.

According to this configuration, the single coil spring (102) further materializes opening of the half rings about their common axis as well. The open angle of the half rings is stably maintained by the coil spring (102) and thus the replacement or insertion of loose leaf or leafs are facilitated.

(4) The loose leaf binder according to the above configuration (1) or (2), wherein a tab (88) is provided at one end of the base plate (42 or 44) which is on the side of compressing the coil spring (102) when the base plates (42, 44) are moved from the first position where the half rings (20, 30) are closed to the second position, and the tab has a guide groove (110) adapted to hold one end of the other base plate and to allow rotation and translation of the other base plate.

With this configuration, opening of the half rings and subsequent stable retention of their open position are made possible. On the other hand, closure of the half rings can be done simply by pushing the rings with fingers as usual.

In further embodiments the following configurations are possible.

(5) The half rings (20, 30) can be restricted to the opening angle of 45-90 degrees about the axis (100).

In the conventional configuration, the opening was about 45 (total angles for both half rings is about 90 degrees) but was not sufficient depending on the situations. The large opening angle makes it much easier to insert or exchange the loose leaf or leaves.

The opening angle is determined by the stopper (108) adapted to restrict the rotation angle of the base plates by engaging with the other base plate at a specific open angle.

(6) With the feature of the above configuration (1), the free end portions of the half rings (20, 30) may take a simple overlapping structure such as nesting structure and make it easy to open the half rings.

(7) The shaft may be a single shaft, or plural shafts supported by the bearings (14) and integrally formed with the base plate which does not have the bearings.

(8) In the embodiment of the above configuration (1), a coil spring (102) is provided which normally biases the base plates (42, 44) toward the first position where the half rings (20, 30) are aligned with each other, and the free end portion (20a) of one of the half ring has a recess and a protrusion vertically recessed and protruded respectively when viewed in the direction of said axis of the shaft and the free end portion (20b) of the other half ring (20a) has a protrusion and a recess vertically protruded and recessed respectively when viewed in the direction of said axis of the shaft. In this embodiment, any one of the structures (2) to (7) may be adopted.

When removing fingers after the half rings are opened, the coil spring (102) exerts its restoring force to the base plates to thereby cause them relatively slide in the longitudinal direction to return half rings in mutually aligned condition.

According to this embodiment, the recess and protrusion of the free end of one half ring simply superpose on the corresponding protrusion and recess of the free end of the other half ring, whereby the both half rings are held stably in the closed position and can be held in mutual alignment in the open position and can be easily opened from the closed position when necessary.

(9) The present invention also provides a binder comprising a pair of base plates and a plurality of half rings supported by the respective bases, wherein a free end of the half ring (20a) has a wedge-like portion (111) having an oblique face (115) adapted to fit to and abut an oblique surface (118) of a wedge-like portion (119) of the mating half ring (20b), a lower surface of the wedge-like portion (111) of the half ring (20a) has a convex (113) and a concave (114), the convex (113) being adapted to fit with the concave (117) of an upper face of the mating half ring (30a), the concave (114) being adapted to fit with the convex (116) of the half ring (30a), and a lower plate (112) is provided in contact with the oblique surface (115) of the wedge portion (111) of the half ring (20a), an upper surface of the lower plate (112) being in contact with the lower surface (120) of the wedge-like portion (119) of the half ring (30a).

The free ends of the both half rings can be closed and make sliding fit each other while keeping their aligned centerline in the same plane, so that the insertion and removal of loose leaves can be stably performed in the open condition. Moreover, during the closing operation of the both half rings, the half-rings are not moved in the axial direction of the base plates, and accordingly unwanted dropping out of the loose leaves is prevented.

### BRIEF DESCRIPTION OF THE DRAWINGS

FIG. 1 illustrates a loose leaf binder in closed condition according to an embodiment of the present invention;

FIG. 2 illustrates a single base plate of the loose leaf binder (both base plate is the same);

FIG. 3 illustrates the loose leaf binder according to the present invention in the unlocked condition, with the both base plate being relatively shifted in the longitudinal direction;

FIG. 4 illustrates the loose leaf binder according to the present invention, with both base plates in the fully opened condition.

FIG. 5 illustrates an enlarged view of an important part of the loose leaf binder according to the present invention;

FIG. 6 illustrates the coiled spring according to the present invention;

FIG. 7 illustrates the cross sectional views taken along the lines A-A, B-B, C-C and D-D of FIG. 1 and the cross sections taking along the lines A-A, B-B, and C-C are also depicted;

FIG. 8 illustrates the cross sectional view taking along E-E and F-F.

FIG. 9 illustrates the structure of the end of the half rings.

FIG. 10 illustrates the stopper for restricting the open angle of the both base plates.

FIG. 11 illustrates the structure of the ends of the half rings.

FIG. 12 illustrates the characterized portion of the present invention according to the sequential operations.

FIG. 13 illustrates the open and closed conditions of the loose leaf binder in connection with the locking means.

FIG. 14 is a perspective view of another embodiment of the structure of the free end portions of the half rings.

FIG. 15 is a perspective view showing the condition where the base plates have been pulled with human fingers to the lock release position.

FIG. 16 shows a perspective view showing the instance when the lock means are released and the

FIG. 17 is a perspective view showing the instance when the open half rings have been returned from the position shown in FIG. 16 to the position where the both half rings are aligned.

### DESCRIPTION OF EMBODIMENT

The present will now be explained in details by making reference to the drawings attached hereto.

### Overall Structure of Binder

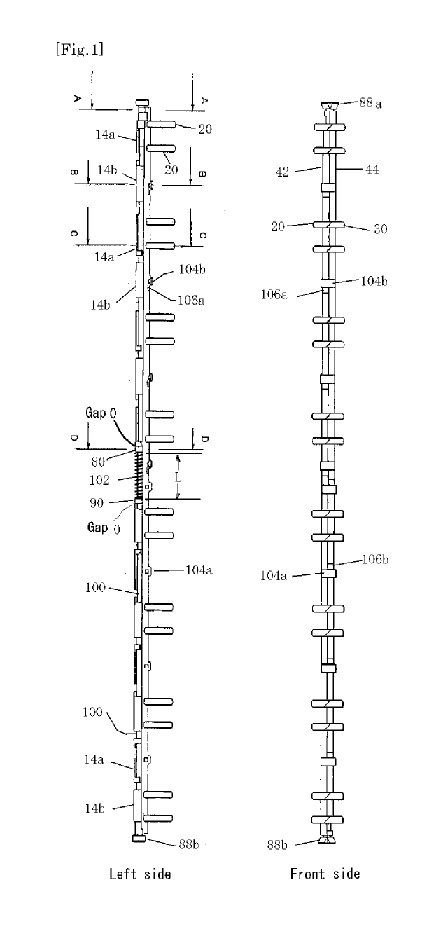

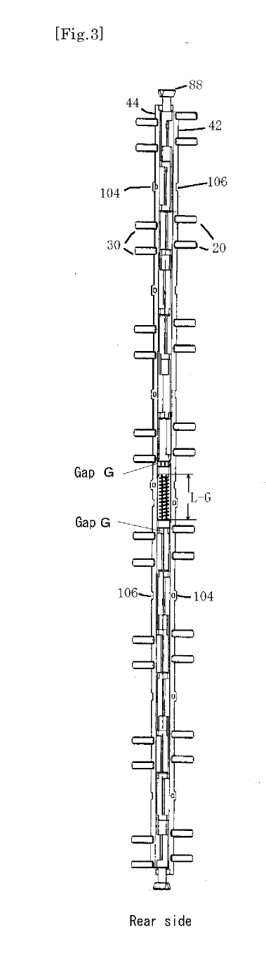

Referring to FIG. 1, the loose leaf binder of this embodiment includes a pair of elongated base plates 42, 44 arranged side-by-side. A plurality of half rings 20, 30 integrally supported respectively on these base plates 42, 44, in such manner that the half rings 20, 30 form closed rings when their respective pairs of the free ends abut each other. A plurality of bearings 14 are formed integrally with rear surfaces of the respective base plates 42, 44 and the bearings 14 have a common axis between the base plates. The base plates can be relatively moved along the common axis between a first position (FIG. 1) where respective pairs of the half rings 20, 30 are aligned with each other and a second position (FIG. 3) where the respective pairs of half rings 20, 30 are out of alignment with each other and the adjacent bearings 14a and 14b have a gap G between them to limit the further movement. The other adjacent bearings 14a and 14b has a gap lager than G so as not to obstruct the movement of the base plates.

At least one hook 104 is formed on the surface of one base plate 42 or 44.

The hook is adapted to engage with the outer edge of the other base plate when the half rings 20, 30 are in the closed position.

At least one lock release groove 108 is formed on the surface of the other base 44 or 42 and is adapted to release the hook 104 from the engagement with the outer edge of the other base plate when the hook 104 drops into the release groove 108.

These bearings 14a, 14b share a single shaft 100 made of metal or resin and the bases 42, 44 which support the half rings 20, 30 can be rotated around the axis of the shaft 100 by a predetermined angle to open and close the half rings 20, 30. It should be understood that the single shaft is one example and a plurality of shafts having a common axis may be used in place of common single shaft. More specifically, the bearing 14a may be integrally formed on the base plate 44 while the bearing 14b is integrally formed on the base plate 42 by molding.

Preferably, a coil spring 102 is mounted on the shaft 100 and is installed between spring retainers 80, 90 (or between the end surfaces of the bearings 14a and 14b) formed on the respective base plates 42, 44, in such manner that the base plates 42, 44 are normally biased toward the first position where the both of the half rings 20,30 are in alignment with each other.

The legs 102a and 102b of the coil spring 102 are engaged with the inner surfaces of the base plates 42, 44 to normally urge the base plates 42, 44 toward their open directions.

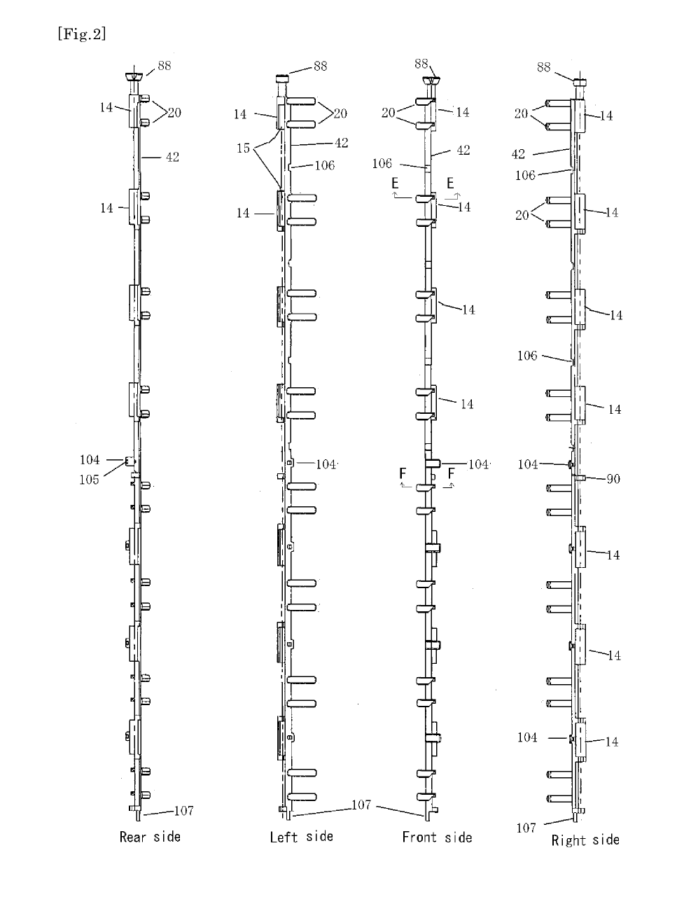

Further, a tab 88a is provided at one end of the base plate (42 or 44) which is on the side of compressing the coiled spring (102) when the base plates are moved from the first position where the half rings (20, 30) are closed toward the second position where the half rings are opened. In the embodiment shown in FIGS. 1-2, the tab 88a is provided on one end of the base plate 42. As shown in FIG. 10, an arcuate guide groove 100 is formed within the tab 88a to retain the arcuate end 107 of the other base plate 44 to allow rotation and translation of the other base plate 44. Similarly, another tab 88b and groove may be provided on the other end of the other base plate 44, too.

### Half Rings

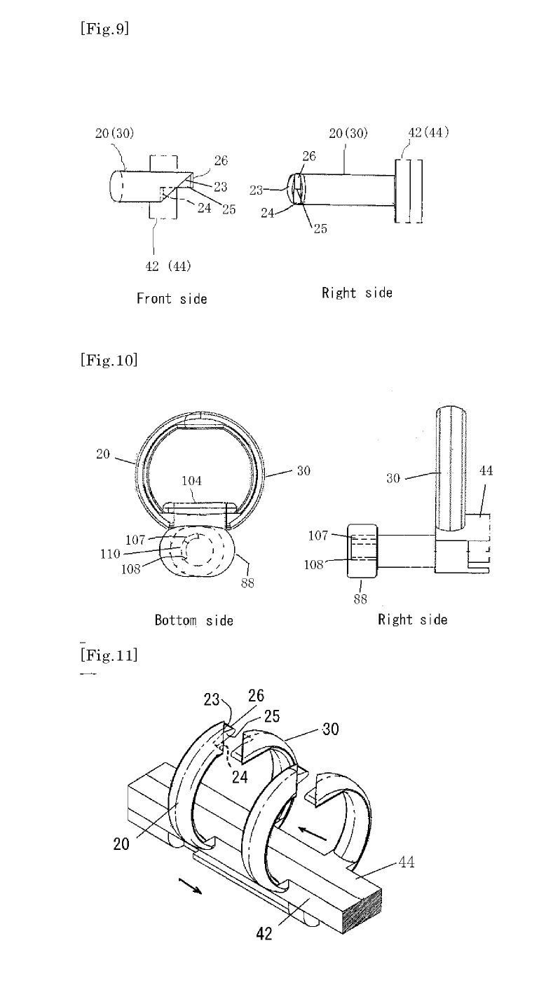

According to the embodiments depicted in the drawings (except for FIGS. 14-17), the free ends of the half rings 20, 30 are of the same shape and when they are rotated by 180 degrees their free ends can be smoothly contacted with each other. FIGS. 9 and 11 illustrate the details of the half rings. The free end of each half ring 20 or 30 is provided with oblique faces 23, a protrusion 26 projecting from between the oblique faces 23 along one side of the vertical surface 25 projecting from the oblique faces 23 along the center line of the half ring, a recess 24 formed on the other side of the vertical surface 25. The half rings 20 and 30 are not hooks but only contact each other, so that a smooth closing and opening of the half rings are made possible. The protrusion 26 of the free end of the half ring has the same curvature as the recess 24 of the other half ring and accordingly they can make a snug fit when they are closed. Also, as shown in FIG. 11, the half rings are opened when the base plates 42, 44 are displaced in the longitudinal direction indicated by the arrow, and are snug fit when the base plates are moved in the reverse direction.

FIGS. 14-17 illustrate the structure of the ends of the rings according to a further embodiment of the invention. In this example, the free ends of the half rings 20, 30 are different from the above-described examples. In order that the left and right side structures (the half ring and the base plate on each side are integral) can be molded with a single mold, the base 42 and its half rings 20 and the base 44 and its half rings 30 have the same shape and but form the structure as shown in FIGS. 14-17 when they are assembled. That is, the structure of the free end of the half rings 20a and the structure of the free end of the half rings 30a are the same. The other portions of the binder are substantially identical to those shown in the other drawings and the explanation is omitted. By adopting this structure, a single mold is sufficient for molding the products, even though the protrusions 113 and the recesses 114 of the free end of each half ring are engaged respectively with the recesses 117 and protrusions 116 of the free end of mating half rings.

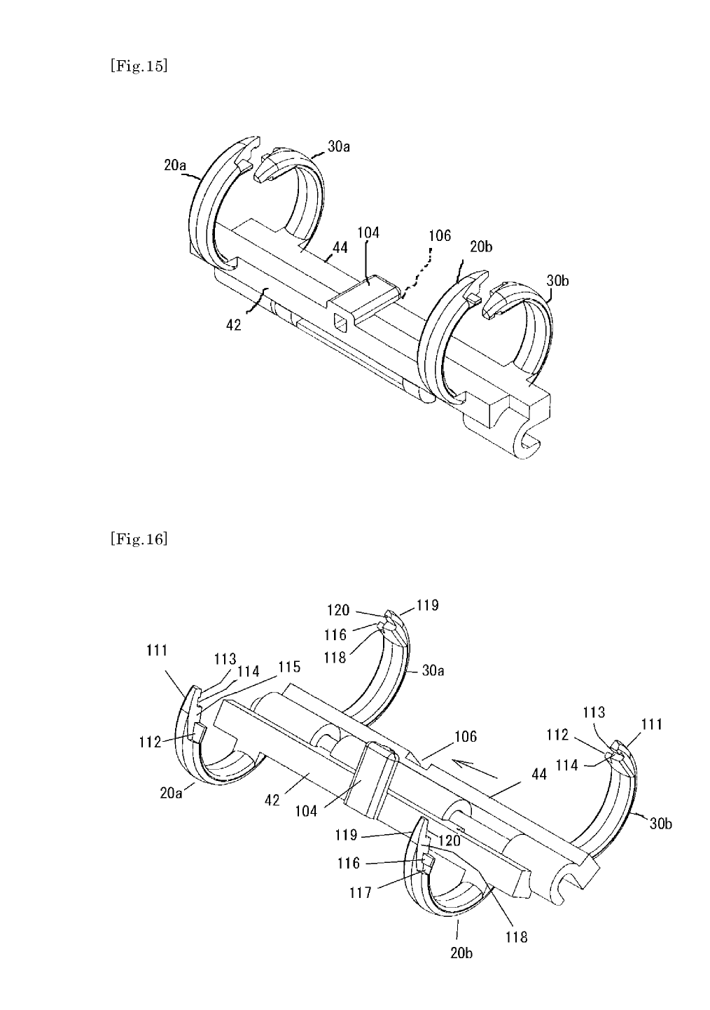

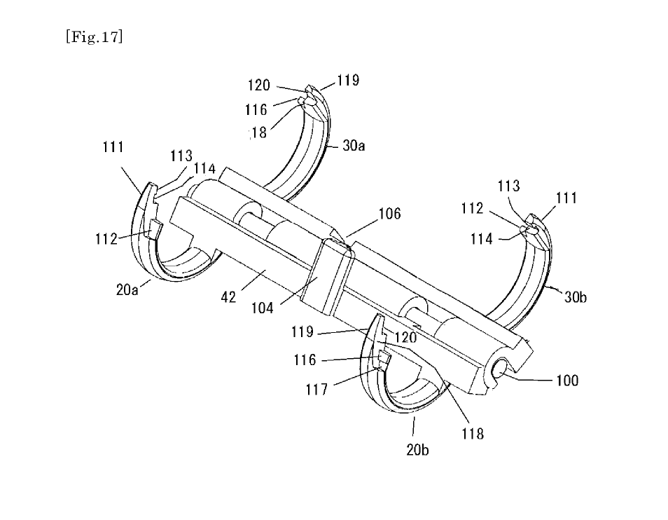

As will be best understood from FIG. 16, the oblique surface 115 of the wedge portion 111 of the half ring 20a is adapted to fit with the oblique surface 118 of the wedge portion 111 of the mating half ring 30a. The lower surface of the wedge portion 111 of the half ring 20a is provided with a protrusion 113 and a recess 114. These protrusion 113 and recess 114 can be snug fit with recess 117 and protrusion 116 on the upper surface of the half ring 30a, respectively. Further, a lower plate 112 is provided adjacent to the oblique surface 115 of the wedge portion 111 of the half ring 20a and the upper surface of the lower plate 112 contacts the lower surface 120 of the wedge portion 119.

Also, as already pointed out, the structure of the half ring 20b is the same as the half ring 30a and the structure of the half ring 30b is the same as the half ring 20a.

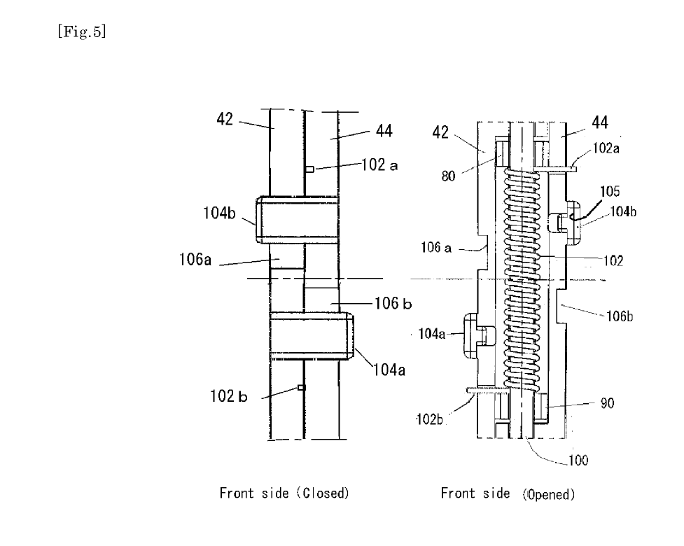

Explaining now the operation of this embodiment, the base plates 42 and 44 are moved to the normal closed position as shown in FIG. 14 by a spring similar to the spring 102 as shown in FIG. 5, the half rings 20a and 20b are abutted with half rings 30a and 30b respectively, and the rock member 104 is out of alignment from the lock release groove 103 and is engaged with the edge of the base plate 44.

Next, when the base plate 44 is pulled with user's fingers in the right lower direction as shown in FIG. 15 against the force of the spring 102, the lock is unlocked upon the dropping of the rock member 104 dropped into the lock release groove 106. When this occurs, the spring 102 urges through its legs 102a and 102b (see FIG. 5) to open the half rings 30a and 30b and 32a and 32b completely as shown in FIG. 16. Upon release of fingers, the spring 102 works to return the both half rings to the mutually aligned position (FIG. 17). The loose leaf or leaves can be inserted or removed (FIG. 17)

Also, after the insertion, exchange or removal of the loose leaf or leaves is finished, the user pushes the half rings 102 to the closed position against the resistance of the spring legs 102a and 102b, so that the half rings are smoothly moved to the position of mutual abutment of the free ends of the half rings. At the same time, the lock member 104 is also engaged with the outer edge of the base plate 44 to lock the base plates (returns to the state shown in FIG. 14). In this example, the protrusion 113 and the recess 114 are brought to fit the recess 117 and the protrusion 116 of the free ends of the half rings respectively and the oblique surfaces 115 and 118 of the wedge portion 111 and 119 are contacted with each other. The protrusion 113 and the recess 114 may be lightly engaged with each other and a strong engagement is not necessarily required. The closure of the rings are smoothly done and the half rings are already in mutual alignment in the opened state so that the insertion or removal of loose leaf or leaves and closure of the half rings are easily done.

### Lock Member and Lock Release Groove

One feature of the present invention resides in the combination of the means for locking the base plates 42 and 44 in the closed position of the half rings 20 and 30, provided by the combination of a locking member 104 and a lock-release groove 106.

Referring to FIG. 1 (complete binder), FIG. 2 (body molded from plastic resin which constitutes each base plate) and FIG. 5 (partial enlarged view), the base plates 42 and 44 are provided with a plurality of lock members 104 and the corresponding same number of lock-release members 106. If the sides of the base plates 42 and 44 are distinguished by the symbols “a” and “b” respectively, the lock members 104a and lock-release grooves or recesses 106b are provided adjacent to each other and the lock members 104b and lock-release members 106a are provided adjacent to each other. The spacing between them is within the range of relative movement of the base plates. Such locking structure may be provided only one place but plural pairs are preferred for securing a surer locking function (8 pairs in the embodiment).

As seen from FIGS. 5, 7 and 10, the lock members 104 are provided with hooks 105. In the relative position of the base plates where the half rings 20, 30 are closed to form rings, the lock members 104 extend from the surface of the base plate 42 along the surface of the base plate 44 and engage with the outer edge of the base plate 44. As shown in FIG. 3, when the base plates are relatively moved in the longitudinal direction by pulling the tab 88, the hooks 105 are almost immediately dropped into the lock release grooves 106. The restriction between the base plates is thus released and the half rings are opened by the weight exerted from the loose leaf or leaves. Thus, according to the present invention, hooks at the free ends of the half rings are dispensed with, while the engagement and disengagement of the lock is made possible by the relative positional relationship among the hooks 105 of the lock members 104, the lock release grooves 106 and the outer edges of the base plates.

Thus, the free ends of the half rings 20, 30 can be maintained in the closed condition without use of hooks at the ends of the half rings, and the free ends of the half rings can have any shape so long as they partly overlap each other. Also, with this configuration, the plastic molding mold is made simple.

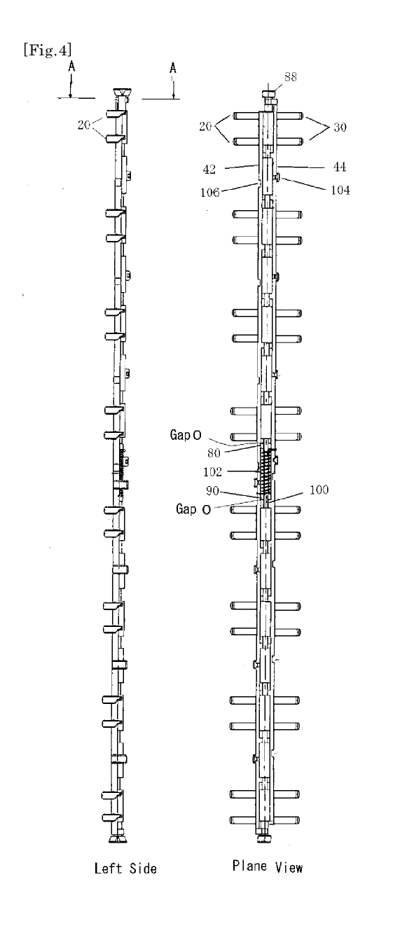

More preferably, by adopting a coil spring 102 having legs 102a and 102b as shown in FIGS. 4-6, the base plates 42, 44 will be immediately returned to the position where the open half rings 20, 30 are in line with each other.

### Open Angle and Stopper

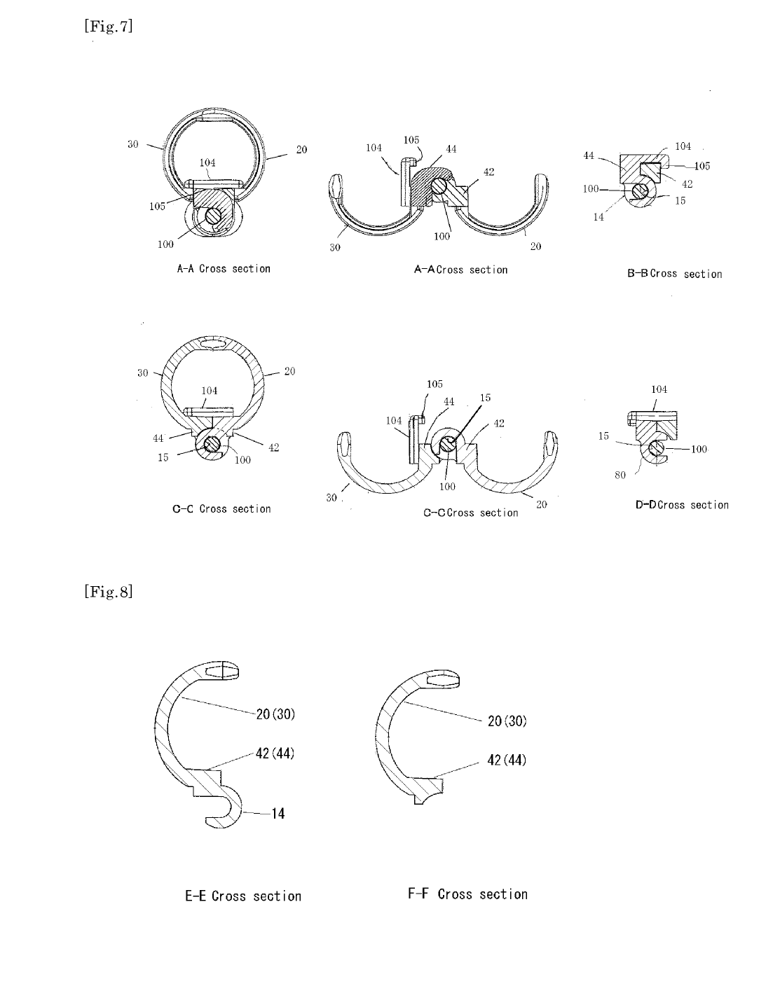

Further, as shown in FIGS. 4, 5 and 12, when the coil spring according to the preferred embodiment is used, the both legs 102a and 102b function to urge the inner surfaces of the base plates 42, 43 immediately upon release of the locks, thereby causing rotation of the base plates in the direction of opening of the half rings. In the depicted embodiment, the mutual opening angle is up to 180 degrees (90 degrees at the minimum) as shown in the A-A cross sectional view in FIG. 7 (that of the open condition). The opening angle can be adjusted to 90-180 degrees if an appropriate stopper is provided in the inner space of the tab 88 as shown in FIG. 10 or at any location. Also, the open angle may be maintained under the force of the coil spring 102. The open angle can be designed in such manner that the both base plates are brought into interference with each other at a certain angle. For example, in FIG. 10, an arc shaped groove 110 having a stopper 108 is formed within the tab 88 of one base plate and arc-shaped end 107 of the base plate of the other base plate is inserted in the groove 110. The stopper may have any structure if the both base plates are stopped with a given open angle.

### Coil Spring

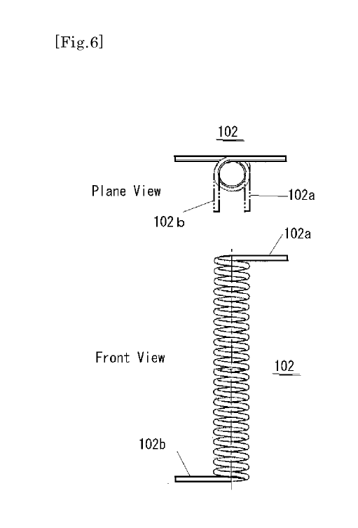

The coil spring is not necessarily required but preferred. An example of the coil spring 102 is explained by making reference to FIGS. 5-6. In this example, the coil spring is capable of giving 90 degrees of opening angle to each base plate (180 degrees in total for both base plates) but any other opening angle larger than 45 degrees may be used by designing the coil spring with a smaller opening angle. The coil spring 102 is provided with legs 102a and 102b which extend in the opposite directions under non-stress condition. The total length of the coil spring is slightly larger than the distance L between the coil spring stops 80 and 90 when the half rings are mutually aligned. For this reason, the coil spring 102 is slightly compressed and accordingly the half rings 20, 30 are always biased in the longitudinal direction so as to restore their aligned condition both in the open and closed conditions. Moreover, both legs 102a, 102b in the mounted condition receive always a torsional stress so as to push open the half rings to a predetermined angle.

The coil spring 102 is, in this example, produced by molding from a highly rigid and tough plastic such as polypropylene and the natural length is larger than the retaining distance L. Accordingly, the coil spring receives a slight compression stress in the installed condition from the spring stops 80,90 and the both legs 102a,102b are bent to the torsion angle under the compression stress as depicted by the two dot chain line in FIG. 6, so that the legs push the inside edges of the base plates. The open angle of the legs 102a, 102b and the resilience of the spring is designed to satisfy these conditions. The coil spring 102 may be produced from spring steel or tough synthetic resin.

When the half rings 20, 30 are in the closed condition and both base plates 42, 44 are in the locked condition, the legs 102a, 102b of the coil spring 102 pushes the opposing inner edges of the base plates 42, 44 in a posture as shown by the chain line in FIG. 6. In this way, the coil spring 102 performs dual functions, namely a function of normally pushing both of the base plates in the longitudinal direction toward the position where the half rings 20 and 30 are aligned to each other, and a function of forcibly urging the base plates to open the half rings when the lock is released.

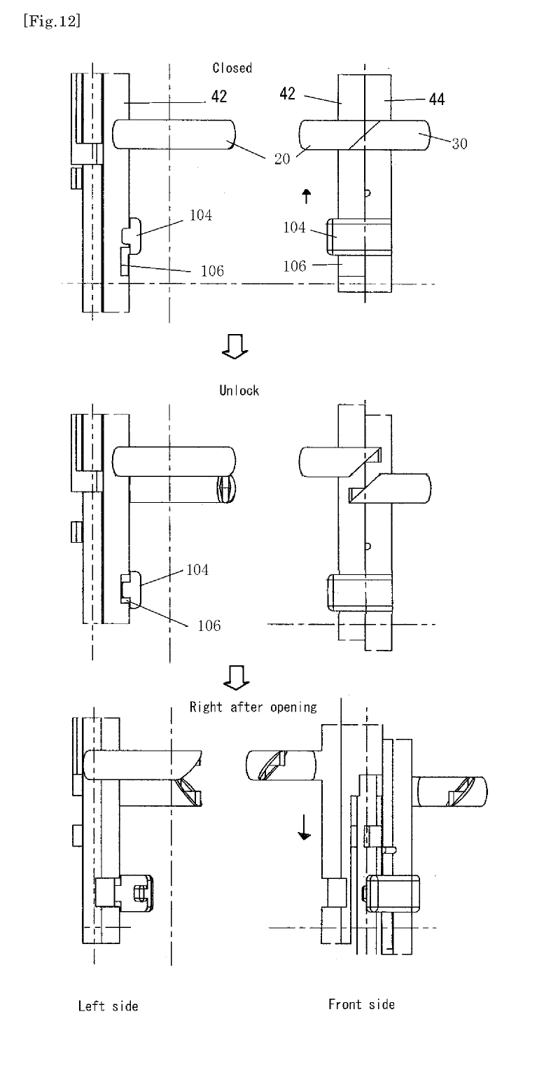

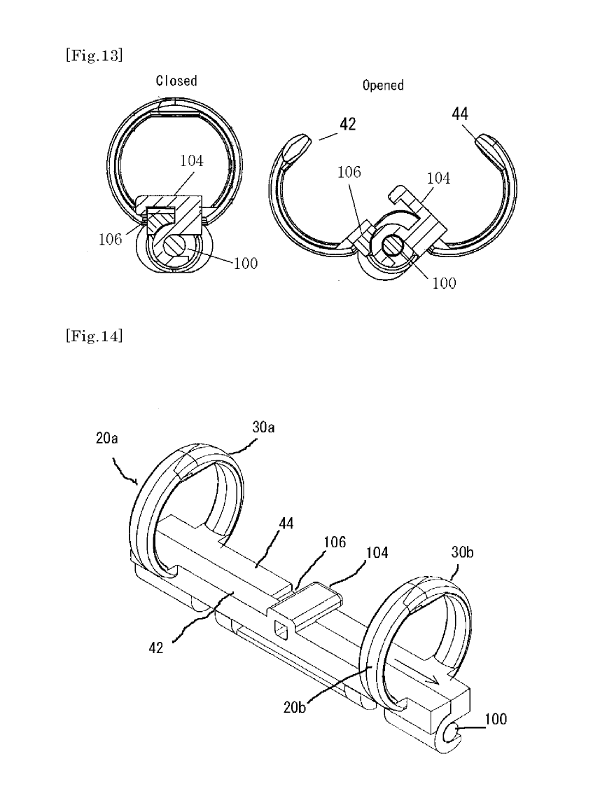

Explaining this functions by making reference to FIG. 12, in the locked condition in which the lock member 104 and the edge of the base plate 42 are engaged, the half rings 20 and 30 are mutually aligned to form complete rings (top part of this figure). When the base plat 42 is pulled with fingers in the direction indicated by a black arrow against the compression force, the lock member 104 slides along the edge of the base plate 42 and drops into the lock release groove 106 to become the unlocked condition (middle part of this figure). When this occurred, the both legs 102a, 102b of the coil spring 102 push the inner surfaces of the base plates 42, 44 in the outer directions, the base plates 42, 44 as well as the half rings 20, 30 are forcibly urged toward the stop positions defined by the stopper (bottom part of this figure). Upon the release of the fingers, the base plate 42 returns to the original position under the compression stress of the coil spring 102 while the half rings are kept open. After loose leafs have been exchanged, the half rings are pushed toward mutual direction with fingers, the half rings are returned to the closed condition shown at the top of FIG. 12.

### Base Plates

FIG. 2 illustrates one of the base plates used in this embodiment. The base plate is symmetrical with respect to the central point of the base plate. Accordingly, if the base plate is rotated about the central point of FIG. 2 by 180 degrees, the shape is identically superposed on the original shape. In other words, a pair of base plates of the same structure and connected with a shaft 100, the binder of the present invention is completed. FIG. 1 shows a combination of a pair of base plates and a single shaft 100 is supported by the bearing 14a and 14b. FIG. 8 shows the cross sectional views taken along the lines E-E and F-F.

### Bearings

FIG. 7 shows cross sectional views taken along the lines A-A, B-B, C-C and D-D of closed rings of FIG. 1. Also, the open conditions taken along the lines A-A and C-C are also depicted. The bearings 14a, 14b have each C-shaped so that the cylindrical shaft 100 can be inserted from lateral direction (see also FIG. 8). Both of the base plates are side-by-side arranged with the inner edge are contacted to form cylindrical bearings, and a single shaft is longitudinally inserted through the bearings to complete the binder.

As an alternative mode, instead of using the bearings 14a,14b and the single shaft 100, a binder may comprise a plurality of bearings 14 integrally molded to the rear side of the base plates 42, 44, and a plurality of shafts integrally molded to the rear side of the base plates 42, 44 supported by the respective bearings 14.

### EXPLANATION OF THE SYMBOLS

14, 14a, 14b: bearing, 15: semi-cylindrical bearing surface, 20, 30: half rings, 23: oblique surface, 24: recess, 25: vertical surface, 26: protrusion, 42, 44: base plate, 80, 90 spring stop, 88: tab, 100 shaft, 102: coil spring, 102a, 102b: spring end, 104: lock member, 105: 106: 107: 108: 110: G: gap between the bearings, L: distance between the spring stops at the time of alignment of the bearings. 111: wedge portion, 112: lower plate, 113: protrusion, 114: recess, 115: oblique surface, 116: protrusion, 118: oblique surface. 119: wedge-shape end, 120: bottom surface,

1. A loose leaf binder comprising: a pair of elongated base plates (42, 44) arranged side-by-side; a plurality of half rings (20, 30) integrally supported respectively on these base plates, in such manner that half rings form closed rings when their respective pairs of the free ends abut each other; a plurality of bearings (14) formed integrally with rear surfaces of the respective base plates (42, 44) and having a common axis between the base plates, a gap formed between the bearings (44) in such manner that the base plates can be relatively moved along the common axis between a first position where respective pairs of half rings (20, 30) are aligned with each other and a second position where the respective pairs of half rings (20, 30) are not aligned; and a shaft or shafts supported by the bearings (14) on the rear surface of the base plates (42, 44), wherein
at least one hook (104) is formed on the one base plate (42 or 44) and adapted to engage with an outer edge of the other base plate when the half rings (20, 30) are in the closed position, and
at least one lock release groove (106) is formed on the other base plate (44 or 42) and adapted to release the hook (104) from the engagement with the outer edge when the half rings (20, 30) are displaced to the second position where the half rings (20, 30) are not aligned and the hook (104) drops into the lock release groove (106).

2. The loose leaf binder according to claim 1, further comprising a coil spring (102) adapted to normally bias the both base plates (42, 44) toward the first position where the half rings (20,30) are aligned with each other.

3. The loose leaf binder according to claim 2, wherein the coil spring (102) has legs (102a, 102b) engaged with the inner edges of the both base plates (42, 44) the legs normally biasing the half rings (20, 30) toward an open position.

4. The loose leaf binder according to claim 1, wherein a tab (88) is provided at one end of the base plate (42 or 44) which is on the side of compressing the coil spring (102) when the base plates (42, 44) are moved from the first position where the half rings (20, 30) are closed to the second position, and the tab has a guide groove (110) adapted to hold one end of the other base plate and to allow rotation and translation of the other base plate.

5. The loose leaf binder according to claim 1, wherein the half rings (20, 30) can be rotated 45-90 degrees about the axis (100).

6. The loose leaf binder according to claim 1, comprising a portion (106) adapted to restrict the rotation angle of the base plates at a specified open angle.

7. The loose leaf binder according to claim 1, wherein the free ends of the half rings (20, 30) have nesting shapes.

8. The loose leaf binder according to claim 1, wherein the shaft is a single shaft.

9. The loose leaf binder according to claim 1, wherein the shaft supported by the bearing (14) is integrally formed on the base plate which does not have said bearing.

10. The loose leaf binder according to claim 1, wherein the free end of the each half ring (20a) has a recess (114) and a protrusion (113) as viewed in the direction of an axis of the shaft, and the free end (20b) of the mating half ring (30a) has a protrusion (116) and a recess (117) complementary to the recess (114) and the protrusion (113) of the free end of the mating half ring (20a).

11. The loose leaf binder according to claim 10, wherein the coil spring (102) has legs (102a, 102b) engaged with the inner edges of the both base plates (42, 44), the legs normally biasing the half rings (20, 30) toward an rotation direction in which the half ring is opened.

12. The lose leaf binder according to claim 10, which comprises a tab (88) provided at one end of the base plate (42 or 44) which is on the side of compressing the coiled spring (102) when the base plates are moved from the first position where the half rings (20, 30) are closed to a second position, wherein the tab is provided with a guide groove (110) adapted to hold one end of the other base plate and to allow rotation and translation of the other base plate.

13. The loose leaf binder according to claim 10, wherein the half rings (20, 30) can be restricted to the opening angle of 45-90 degrees.

14. The loose leaf binder according to claim 10, which comprises a stopper (108) adapted to restrict the rotation angle of the base plates at a specific open angle.

15. The loose leaf binder according to claim 10, wherein the shaft is a single shaft.

16. The loose leaf binder according to claim 10, wherein the shaft supported by the bearing (14) is integrally formed on the base plate which does not have said bearing.

17. A binder comprising a pair of base plates and a plurality of half rings supported by the respective base plates, wherein a free end of the half ring (20a) has a wedge-like portion (111) having an oblique face (115) adapted to fit to and abut an oblique surface (118) of a wedge-like portion (119) of the mating half ring (20b), a lower surface of the wedge-like portion (111) of the half ring (20a) has a convex (113) and a concave (114), the convex (113) being adapted to fit with the concave (117) of an upper face of the mating half ring (30a), the concave (114) being adapted to fit with the convex (116) of the half ring (30a), and a lower plate (112) is provided in contact with the oblique surface (115) of the wedge portion (111) of the half ring (20a), an upper surface of the lower plate (112) being in contact with the lower surface (120) of the wedge-like portion (119) of the half ring (30a).
